(19) United States
(12) Patent Application Publication
(10) Pub. No.: US 2001/0051108 A1
(43) Pub. Date: Dec. 13, 2001

(54) Sensor and method for determining soot concentrations

(75) Inventor: Ulrich Schonauer, Eggenstein (DE)

Correspondence Address: AKIN, GUMP, STRAUSS, HAUER & FELD, L.L.P., ONE COMMERCE SQUARE, 2005 MARKET STREET, SUITE 2200, PHILADELPHIA, PA, 19103, US

(73) Assignee: Heraeus Electro-Nite International N.V.

(21) Appl. No.: 09/732,602

(22) Filed: Dec. 8, 2000

(30) Foreign Application Priority Data
Dec. 10, 1999 (DE) 199 59 871.1

(51) Int. Cl. G01N 31/10

(52) U.S. Cl. 422/68.1; 422/88; 422/98; 436/152

(57) ABSTRACT

A sensor and method are provided for ascertaining a soot concentration in flowing, soot particle-bearing gases, wherein at least a component stream of a soot particle-bearing gas stream flows through at least one molded element which is open-pored at least in the flow direction, and wherein the temperature of the molded element is measured with at least one temperature probe. The sensor is a soot sensor, which has at least one molded element which is open-pored at least in the flow direction, at least one electric heating element and at least one temperature probe.

### BACKGROUND OF THE INVENTION

The invention relates to a sensor and its use for determining soot concentrations, and further to a method for ascertaining soot concentrations in flowing, soot particle-bearing gases, wherein at least one component stream of a soot particle-bearing, exhaust gas stream flows through at least one molded element which is open-pored in the flow direction, and wherein the temperature of the molded element is measured with at least one temperature probe.

German patent DE 198 17 402 C1 describes a sensor arrangement for quantitative determination of electrically conducting and/or electrically charged particles contained in a gas stream, especially soot particles. Here, an electrode arrangement is used in an exhaust gas conduit carrying the gas stream, wherein the exhaust gas flows around the arrangement. A high voltage in the range of 1000 V to 5000 V is applied to the electrode arrangement by means of a conductor arrangement. The measuring principle is based upon the fact that an electric field generated within the exhaust gas conduit by the electrode arrangement is disturbed when electrically conducting or electrically charged particles flow through it. The electrode arrangement forms a capacitor from which electrical energy is drawn off by the charge of the particles. With constant voltage a charging current must flow to reproduce the original field strength, which current represents a measure for the amount of particles in the exhaust gas stream. At least one segment of the surface of the conductor arrangement is heatable to a temperature, which thermally destroys the particles. The formation of a closed particle layer causing a short circuit is thereby prevented, in that the particles which strike upon the conductor arrangement are immediately burned. Disadvantageous with this sensor arrangement is that high voltages are required.

The problem arises of making available a sensor for ascertaining soot concentrations in flowing gases, which overcomes the disadvantages of sensors known from the prior art.

### SUMMARY OF THE INVENTION

The problem is solved for the sensor in that the sensor is a soot sensor, which has at least one molded element which is open-pored at least in the flow direction, at least one electric heating element and at least one temperature probe. By a molded element which is open-pored at least in the flow direction is very generally to be understood an element with open porosity or penetrating openings or holes in the direction of flow, which pores can be ordered or unordered. Here, it can be a matter of a perforated sheet, a tube, a packet of fibers or wool, a porous ceramic, a porous glass, a porous thin layer or the like. Even a very rough surface can be used as a molded element which is open-pored in the flow direction. It is advantageous if the molded element, which is open-pored at least in the flow direction, is constructed of a ceramic with a honeycomb construction or a molded element which is open-pored in the flow direction, which is at least partially covered with a catalytically active material, for example with platinum. The electric heating element and the temperature probe can be arranged directly on or in the molded element. The electric heating element, the temperature probe and the molded element can also be arranged on a carrier.

The molded element can, for example, be flowed through by a complete gas stream which has soot particles, or instead only be flowed through by a portion of the gas stream. The molded element should not pick up 100% of the soot from the gas, thus not replace the soot filter. It is sensible that in any given case only a fraction of the soot is picked up from the gas by the flowed-through molded element and, so to speak, a representative portion of soot particles is removed from the exhaust gas.

With respect to the numerous configuration possibilities for sensor geometry of the soot sensor, care must be taken that conductive compounds as, for example, catalytically active material or the soot itself, do not lead to signal disturbances or short circuits, which can endanger a trouble-free operation of the heating elements as well as of the temperature probes. Possibly the use of one or more electrically insulating, soot-impermeable layers between heating element and molded element or between temperature probe and molded element can be necessary for this. The formation of a short circuit by soot can, however, especially on the electric heating element, also be desirable or be used for evaluation purposes.

The sensor is especially suited for ascertaining a soot concentration in flowing, soot particle-bearing gases, which are emitted, for example, by combustion facilities or internal combustion engines.

The problem is solved for the method in that a portion of the soot particles remains adhered to the molded element (4), and in that the molded element (4) is heated at defined time intervals by an electric heating element (3; 3a; 3b) to the ignition temperature of the soot, and in that a development of heat occurring upon combustion of soot particles is used as a direct measure for an amount of soot, which has flowed past the soot sensor.

Here, the time intervals, in which the molded element is heated with the electric heating element, can be selected as fixed. Instead, variable time intervals, which can be selected on the basis of an evaluation of operating data, can be sensible.

For a soot sensor in the exhaust gas conduit of a diesel engine, this can mean, for example, that the heating up of the molded element is started after a predetermined number of cold starts or as a function of diesel fuel consumed. Accordingly, by operating data are generally to be understood information which relate to the generation of exhaust gas and which can be set in some relationship with a development of soot in the exhaust gas.

First, it is possible that, after reaching the ignition temperature of the soot on the molded element (4), the electric heating element (3; 3a; 3b) is operated with a constant heat output, that the heat development occurring due to the combustion of soot particles is measured with the temperature probe (2; 2a; 2b), that the temperature rise is evaluated as a direct measure for the combusted amount of soot particles on the molded element (4), and that the amount of soot which has flowed past the soot sensor is determined therefrom.

For this purpose, an intelligent control unit is necessary, which can convert the rise in temperature into an amount of soot by a predetermined computation routine. The amount of soot, which burns on the molded element, is proportional to the amount of soot which has flowed past the molded element since it was installed or since the last heating up of the molded element.

Second, after reaching the ignition temperature of the soot on the molded element (4), the temperature of the molded element (4) can be kept substantially isothermal by withdrawing heat output of the electric heating element (3; 3a; 3b), and the heat output can be evaluated as a direct measure for the combusted amount of soot particles on the molded element (4), and the amount of soot which has flowed past the soot sensor can be determined therefrom. Here too, an intelligent control unit is necessary.

After evaluating the temperature rise or the change in heat output and conversion into a combusted amount of soot on the molded element upstream of the soot filter, the amount of soot which has flowed past the soot sensor is inferred. For this purpose, a correlation formula, which contains the relationship between deposits on the molded element and the amount of soot which has flowed past, must be stored in the intelligent control unit. If an amount of soot on the molded element has been computed which, for example, lies above a legally specified threshold value, then the emission of an optical or acoustic warning signal or an intervention into the regulation of the combustion process can take place by the control unit.

If, however, an amount of soot on the molded element is computed which, for example, lies below a predetermined threshold value, then no action is initiated by the control unit, but instead the calculated value for the amount of soot is stored. A subsequently started, second determination, repeated at a certain interval from this first determination of the amount of soot on the molded element, must now be processed in connection with the first determination or the value stored for this purpose. The calculated amount of soot from the second determination must be added to the stored value by the control unit, since in this case only the sum of the two values supplies the correct value in the correlation formula. If the threshold value is not exceeded even after the second determination, then the sum from both determinations must be stored and further used for subsequent calculations in accordance with the above formula.

The following five figures should provide an exemplary, detailed explanation of the invention. It should be expressly pointed out that not only a planar construction of the soot sensor, as depicted here, is possible. The arrangement of the molded element on a rod or a tube or the use of a massive, self-supporting molded element is also possible.

### BRIEF DESCRIPTION OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a sectional side view of a simple soot sensor on a carrier according to a first embodiment of the invention;

FIG. 2 is a sectional side view of a soot sensor with a heating element in a soot-free gas space according to a second embodiment;

FIG. 3 is a sectional side view of a soot sensor with an additional temperature probe in a soot-free gas space according to a third embodiment;

FIG. 4 is a sectional side view of a soot sensor with an additional temperature probe and an additional heating element in the exhaust gas stream, as well as an additional temperature probe in a soot-free gas space according to a fourth embodiment; and

FIG. 5 is a graphical diagram for measuring the temperature progression of the molded element of FIG. 1 with and without soot.

### DETAILED DESCRIPTION OF THE INVENTION

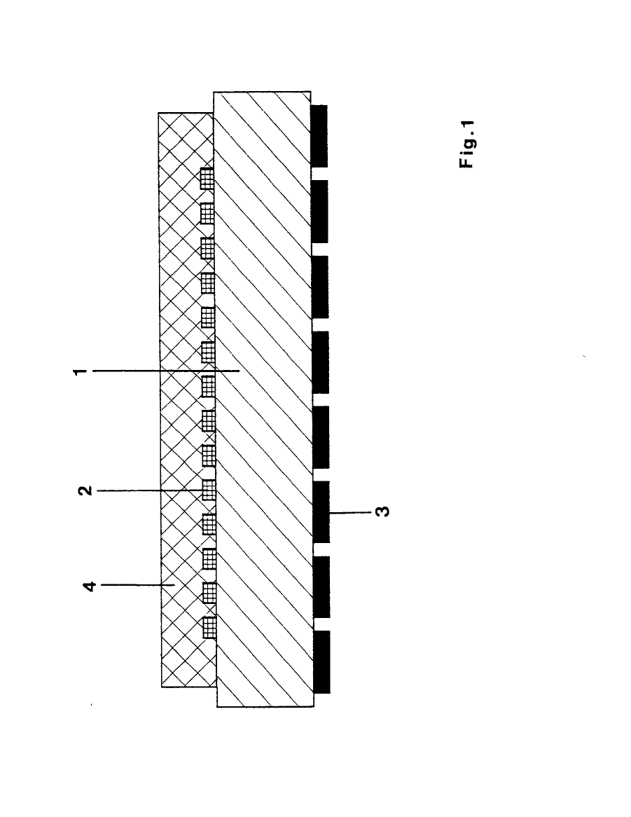

FIG. 1 shows a soot sensor in cross section with a carrier 1 made of Al₂O₃ ceramic. On one side of the carrier 1 a meander-shaped temperature probe 2 is arranged, here a platinum resistance element made by thin film technology. This temperature probe 2 is covered by an open-pored ceramic molded element 4 made of Al₂O₃. On the other side of the carrier 1 a meander-shaped heating element 3 is arranged.

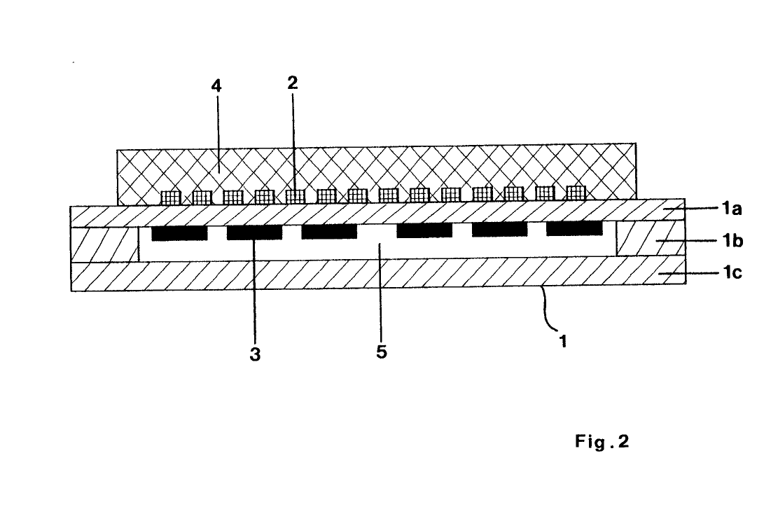

FIG. 2 depicts a soot sensor in cross section with a carrier 1, which is manufactured from the gas-impermeable, ceramic sheets 1a; 1b; 1c using lamination technology. On one side of the carrier 1 a meander-shaped temperature probe 2 is arranged, covered by an open-pored ceramic molded element 4. The carrier 1 forms a soot-free gas space 5, in which a protected, meander-shaped heating element 3 is arranged.

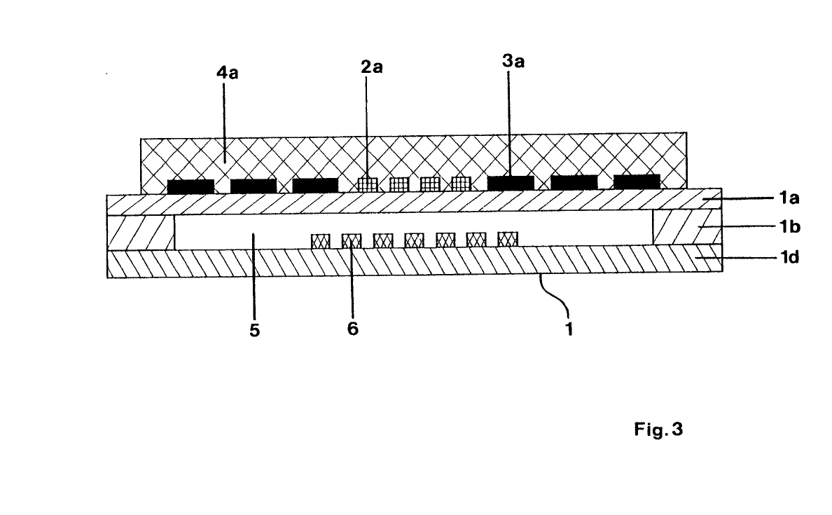

FIG. 3 shows a soot sensor in cross section with a carrier 1 of Al₂O₃, which is manufactured from the gas-impermeable, ceramic sheets 1a; 1b and the gas-permeable, ceramic sheet 1d using lamination technology. On one side of the carrier 1 a meander-shaped temperature probe 2a is arranged, surrounded by a meander-shaped heating element 3a. The individual paths of the temperature probe 2a and the heating element 3a are covered by an electrically insulating, soot-impermeable, thin layer of Al₂0₃ (not represented here), which in turn is covered by the open-pored ceramic molded element 4a. The pore surfaces of the molded element 4a are coated with a catalytically active material, here platinum. The carrier 1 forms a soot-free gas space 5, in which an additional temperature probe 6 is arranged for independent measurement of the exhaust gas temperature. The gas-permeable ceramic sheet 1d makes possible an access of the exhaust gas without soot particles into the gas space 5 and thereby contributes to increasing the response rate of the additional temperature probe 6.

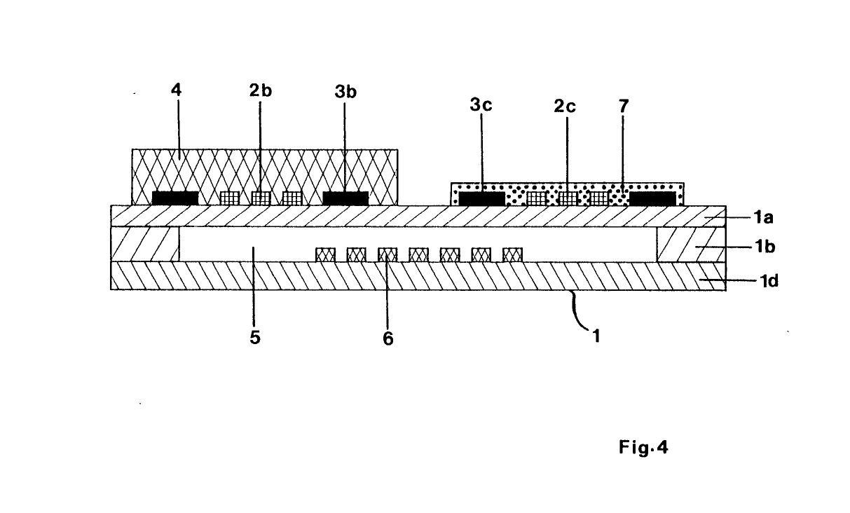

FIG. 4 illustrates a soot sensor in cross section with a carrier 1, which is manufactured from the gas-impermeable, ceramic sheets 1a; 1b and the gas-permeable, ceramic sheet 1d using lamination technology. On one side of the carrier 1 a meander-shaped temperature probe 2b is arranged, surrounded by an annular heating element 3b. The temperature probe 2b and heating element 3b are covered by an open-pored ceramic molded element 4. On this side of the carrier 1 a further meander-shaped temperature probe 2c is arranged, surrounded by an annular heating element 3c. The temperature probe 2c and heating element 3c are coated with a soot-impermeable protective layer 7. The parallel operation of the temperature probes 2b; 2c and the heating elements 3b and 3c makes possible a difference measurement. Here, the heating elements 3b and 3c are operated in the same manner by a control unit, and upon reaching the ignition temperature of the soot, the measured signal of temperature probe 2c subtracts from that of temperature probe 2b. A measuring result arises which unambiguously and with great accuracy can be attributed to the development of heat, which occurs due to the combustion of soot. The carrier 1 forms a soot-free gas space 5, in which an additional temperature probe 6 is arranged for independent measurement of the exhaust gas temperature. The gas-permeable, ceramic sheet 1d makes possible an entry of the exhaust gas without soot particles into the gas space 5 and contributes thereby to increasing the response rate of the additional temperature probe 6.

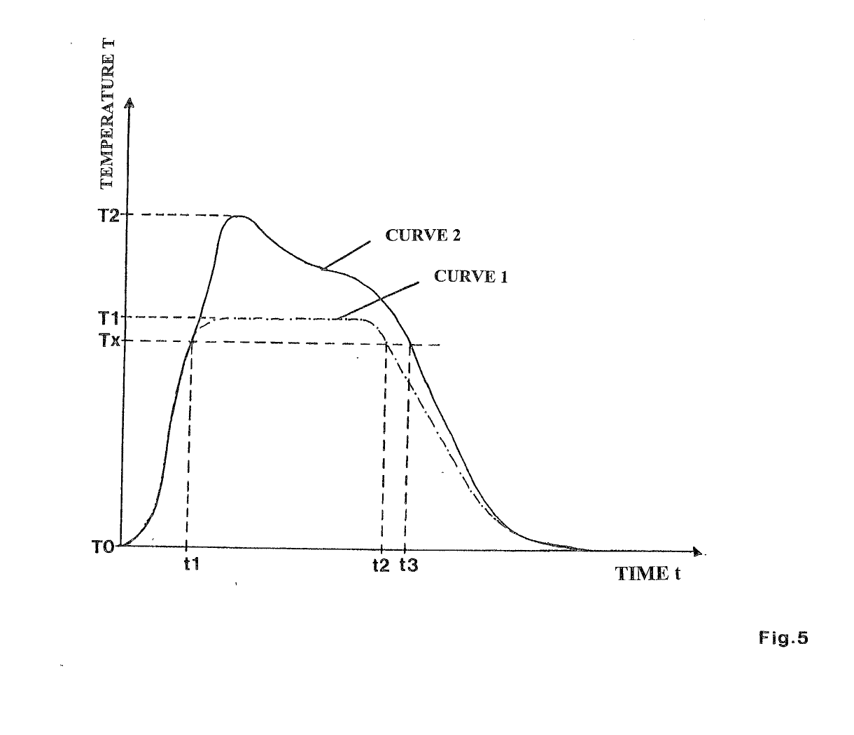

FIG. 5 shows the temperature progression of a molded element, as shown in FIG. 1, which is heated with a heating element proceeding from a temperature T0 in the exhaust gas conduit of a diesel motor vehicle. This temperature T0 can generally be synonymous with the cold start temperature of the motor or with any desired temperature of the exhaust gas stream. Here, the case is considered that the molded element is heated during the pre-glow process upon cold start of the motor vehicle to the ignition temperature of the soot. A rapid change in the ambient temperature, which would influence the measurement and would therefore have to be recorded and compensated for, is not to be feared at this point in time (thus before starting the motor). Consequently, an additional measurement of the ambient temperature is not necessary in this case. Curve 1 shows the temperature progression, taken with a temperature probe, of the molded element without soot loading, wherein the heat output of the heating element is kept constant over a time t. This curve 1 represents a reference curve, which should always be stored in the control unit of the motor vehicle for the evaluation of the curves with soot.

Curve 2 shows the temperature progression, taken with the same temperature probe, of the molded element with soot loading, wherein the heat output is kept constant over a time t. Due to the combustion of the soot, higher temperatures are reached in curve 2 than in curve 1. The difference between the maximum temperatures T1 and T2 of curves 1 and 2 can be used for calculating the amount of soot on the molded element, and this value can be brought into relationship with the amount of soot found on an after-connected soot filter by a correlation formula stored in the control unit, which formula was determined in advance especially for the measuring structure used and the materials used in the soot filter and the soot sensor. Of course, for an average technician, instead of such a mathematical evaluation of the curves based on their slopes, an integral formation or by an evaluation over time is also possible in a known manner. Thus, for example, for curve 1a time t2−t1 can be determined and for curve 2a time t3−t1 can be determined, which indicates how long the soot sensor has a temperature T above a temperature Tx. If a temperature Tx is selected somewhat below T1, then the differences between the time t2−t1 and the time t3−t1 are shown most clearly. A difference between the times (t2−t1) and (t3−t1), which indicate a subsequent cooling off due to the combustion of soot on the soot sensor (represented in curve 2), can be correlated with the combusted amount of soot, since a value t2−t1 for a temperature Tx of an unloaded sensor is stored in a control unit for purposes of comparison, and at a temperature Tx of the soot sensor the time t3−t1 is determined, and the difference is formed with the aid of the stored value.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A sensor for use in flowing, soot particle-bearing gases, wherein the sensor is a soot sensor comprising at least one molded element (4) which is open-pored in a flow direction of the gases, at least one electric heating element (3; 3a; 3b; 3c), and at least one temperature probe (2; 2a; 2b; 2c).

2. The sensor according to claim 1, wherein the molded element (4) which is open-pored at least in the flow direction is made of a ceramic with honeycomb construction.

3. The sensor according to claim 1, wherein the molded element (4) is at least partially coated with a catalytically active material.

4. The sensor according to claim 1, wherein the electric heating element (3; 3a; 3b; 3c) and the temperature probe (2; 2a; 2b; 2c) are arranged directly on or in the molded element (4).

5. The sensor according to claim 1, wherein the electric heating element (3; 3a; 3b; 3c), the temperature probe (2; 2a; 2b; 2c) and the molded element (4) are arranged on a carrier (1; 1a; 1b; 1c; 1d).

6. The sensor according to claim 1, wherein the sensor is adapted for ascertaining a soot concentration in the flowing, soot particle-bearing gases.

7. A method for ascertaining a soot concentration in flowing, soot particle-bearing gases, comprising flowing at least one component stream of a soot particle-bearing, exhaust gas stream through at least one molded element which is open-pored in flow direction of the gases, measuring a temperature of the molded element with at least one temperature probe, wherein a portion of the soot particles remains adhered to the molded element (4), heating up the molded element (4) defined time intervals by an electric heating element (3; 3a; 3b) to an ignition element of the soot, and using a development of heat occurring upon combustion of soot particles as a direct measure for an amount of soot which has flowed past the soot sensor.

8. The method according to claim 7, wherein the time intervals are selected as fixed.

9. The method according to claim 7, wherein the time intervals are selected on a basis of an evaluation of operating data.

10. The method according to claim 7, further comprising, after reaching the ignition temperature of the soot on the molded element (4), operating the electric heating element (3; 3a; 3b) with a constant heat output, measuring the development of heat occurring from combustion of soot particles with the temperature probe (2; 2a; 2b), evaluating a temperature rise as a direct measure for a combusted amount of soot particles on the molded element (4), and determining therefrom the amount of soot which has flowed past the soot sensor.

11. The method according to claim 7, further comprising, after reaching the ignition temperature of the soot on the molded element (4), maintaining the temperature of the molded element (4) substantially isothermal by withdrawing a heat output of the electric heating element (3; 3a; 3b), evaluating the heat output as a direct measure for the combusted amount of soot particles on the molded element (4), and determining therefrom the amount of soot which has flowed past the soot sensor.
